(19) United States
(12) Patent Application Publication
(10) Pub. No.: US 2026/0127017 A1
(43) Pub. Date: May 7, 2026

(54) Workload Placement in a Containerized Application Environment

(71) Applicant: Dell Products L.P., Round Rock, TX (US)

(72) Inventors: Vinay Sawal, Fremont, CA (US); Mihai Lazar, Nepean (CA); Ramesh Ganapathi, Chennai (IN); Sanjeev Sharma, Bengaluru (IN)

(21) Appl. No.: 18/938,089

(22) Filed: Nov. 5, 2024

(51) Int. Cl. G06F 9/455; G06F 9/50; G06F 16/901

(52) U.S. Cl. CPC G06F 9/45558; G06F 9/5061; G06F 16/9024; G06F 2009/4557

(57) ABSTRACT

A system can determine a directed graph, wherein respective graph nodes of the directed graph comprise respective application containers of a group of application containers that are configured to execute upon a group of computing nodes and that are part of a containerized application architecture, and wherein respective edges of the directed graph identify respective service affinities between the respective application containers. The system can partition the respective graph nodes based on the respective service affinities, to produce respective partitioned groups of graph nodes. The system can identify a placement of the respective application containers on the respective computing nodes based on the partitioned groups of graph nodes, wherein the placement satisfies a defined optimality criterion. The system can deploy the respective application containers on the respective computing nodes based on the placement.

### BACKGROUND

A computer application can generally be implemented with a containerized architecture.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can determine a directed graph, wherein respective graph nodes of the directed graph comprise respective application containers of a group of application containers that are configured to execute upon a group of computing nodes and that are part of a containerized application architecture, and wherein respective edges of the directed graph identify respective service affinities between the respective application containers. The system can partition the respective graph nodes based on the respective service affinities, to produce respective partitioned groups of graph nodes. The system can identify a placement of the respective application containers on the respective computing nodes based on the partitioned groups of graph nodes, wherein the placement satisfies a defined optimality criterion. The system can deploy the respective application containers on the respective computing nodes based on the placement.

An example method can comprise creating, by a system comprising at least one processor, a directed graph, wherein respective graph nodes of the directed graph comprise respective application containers of a group of application containers that are configured to execute upon a group of computing nodes, and wherein respective edges of the directed graph identify respective service affinities between the respective application containers. The method can further comprise partitioning, by the system, the respective graph nodes based on the respective service affinities, to produce respective partitioned groups of graph nodes. The method can further comprise determining, by the system, a placement of the respective application containers on the respective computing nodes based on the partitioned groups of graph nodes, wherein the placement satisfies a criterion specifying at least a threshold performance. The method can further comprise executing, by the system, the respective application containers on the respective computing nodes based on the placement.

An example non-transitory computer-readable medium can comprise instructions that, in response to execution, cause a system comprising a processor to perform operations. These operations can comprise generating a directed graph, wherein respective graph nodes of the directed graph comprise respective application containers of a group of application containers that are configured to execute upon a group of computing nodes, and wherein respective edges of the directed graph identify respective service affinities between the respective application containers. These operations can further comprise partitioning the respective graph nodes based on the respective service affinities, to produce respective partitioned groups of graph nodes. These operations can further comprise deploying the respective application containers on the respective computing nodes based on a placement of the respective application containers on the respective computing nodes, wherein the placement is based on the partitioned groups of graph nodes, and wherein the placement satisfies a criterion specifying an optimality applicable to container placement.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate workload placement in a containerized application environment, in accordance with an embodiment of this disclosure;

FIG. 2 illustrates another example system architecture that can facilitate workload placement in a containerized application environment, in accordance with an embodiment of this disclosure;

FIG. 3 illustrates another example system architecture that can facilitate workload placement in a containerized application environment, in accordance with an embodiment of this disclosure;

FIG. 4 illustrates an example of application graph construction, and that can facilitate workload placement in a containerized application environment, in accordance with an embodiment of this disclosure;

FIG. 5 illustrates an example of graph partitioning, and that can facilitate workload placement in a containerized application environment, in accordance with an embodiment of this disclosure;

FIG. 6 illustrates an example of heuristic placement, and that can facilitate workload placement in a containerized application environment, in accordance with an embodiment of this disclosure;

FIG. 7 illustrates an example process flow that can facilitate workload placement in a containerized application environment, in accordance with an embodiment of this disclosure;

FIG. 8 illustrates another example process flow that can facilitate workload placement in a containerized application environment, in accordance with an embodiment of this disclosure;

FIG. 9 illustrates another example process flow that can facilitate workload placement in a containerized application environment, in accordance with an embodiment of this disclosure;

FIG. 10 illustrates another example process flow that can facilitate workload placement in a containerized application environment, in accordance with an embodiment of this disclosure; and

FIG. 11 illustrates an example block diagram of a computer operable to execute an embodiment of this disclosure.

### DETAILED DESCRIPTION

### Overview

While the present examples generally relate to fifth generation (5G) broadband cellular communications, it can be appreciated that the present techniques can generally be applied to other scenarios, such as Long Term Evolution (LTE) or sixth generation (6G) broadband cellular networks.

In the domain of 5G telecommunication (“telco”) networks, efficient workload placement can be crucial for ensuring optimal (or satisfactory) resource utilization, and meeting stringent network performance requirements. Where the present examples describe an optimal (or other superlative) approach, it can be appreciated that there can be examples of the present techniques that implement a satisfactory approach.

Unlike traditional cloud environments, 5G telco workloads can depend not only on cluster resources (e.g., compute, memory, and storage), but also on the real-time utilization of the 5G network itself, measured by the number of connected user equipments (UEs) or phones handled by a given cluster.

Furthermore, 5G telco applications can have specific constraints related to network bandwidth and latency, both between UEs and applications, as well as between applications themselves. These constraints can play a critical role in ensuring seamless communication and maintaining a required quality of service (QoS) for various 5G use cases, such as ultra-low-latency applications, enhanced mobile broadband, and/or massive machine-type communications.

In this context, there can be a problem that relates to a need to develop an intelligent workload placement approach that can optimally allocate and distribute workloads across clusters while considering the available cluster resources, the real-time 5G network utilization, and the required network performance constraints. This problem can be addressed via the present techniques, which can be capable of maximizing resource utilization, maintaining required network performance levels, and ensuring adherence to specified constraints.

The present techniques can comprise a use of a hybrid technique of a modified graph partition and heuristic placement approach to optimally place telco application workloads on a containerized application cluster.

By addressing problems with prior approaches, the present techniques can contribute to the efficient and effective deployment of 5G telco applications, enabling seamless and reliable communication, improved resource utilization, and a better overall user experience in 5G networks.

### Example Architectures, Etc.

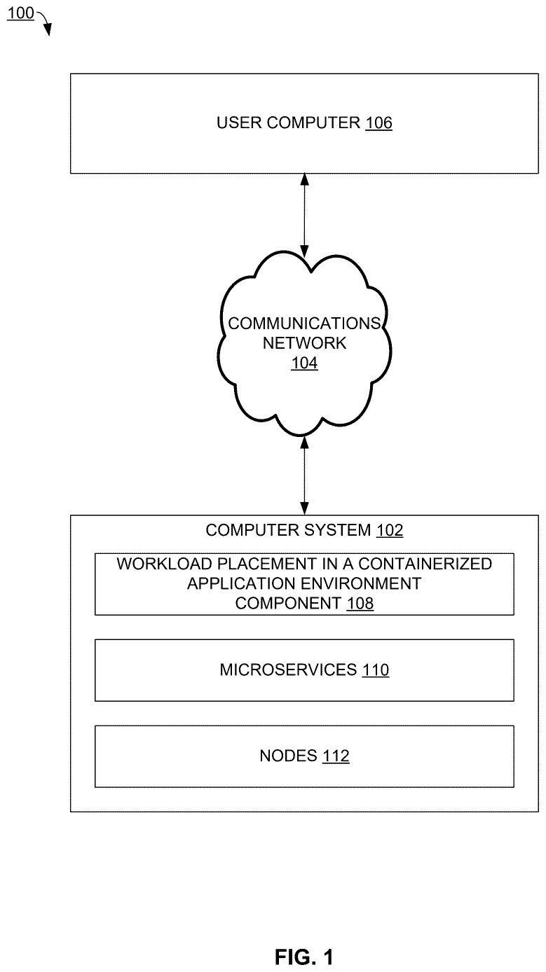

FIG. 1 illustrates an example system architecture 100 that can facilitate workload placement in a containerized application environment, in accordance with an embodiment of this disclosure.

System architecture 100 comprises computer system 102, communications network 104, and user computer 106. In turn, computer system 102 comprises workload placement in a containerized application environment component 108, microservices 110, and nodes 112.

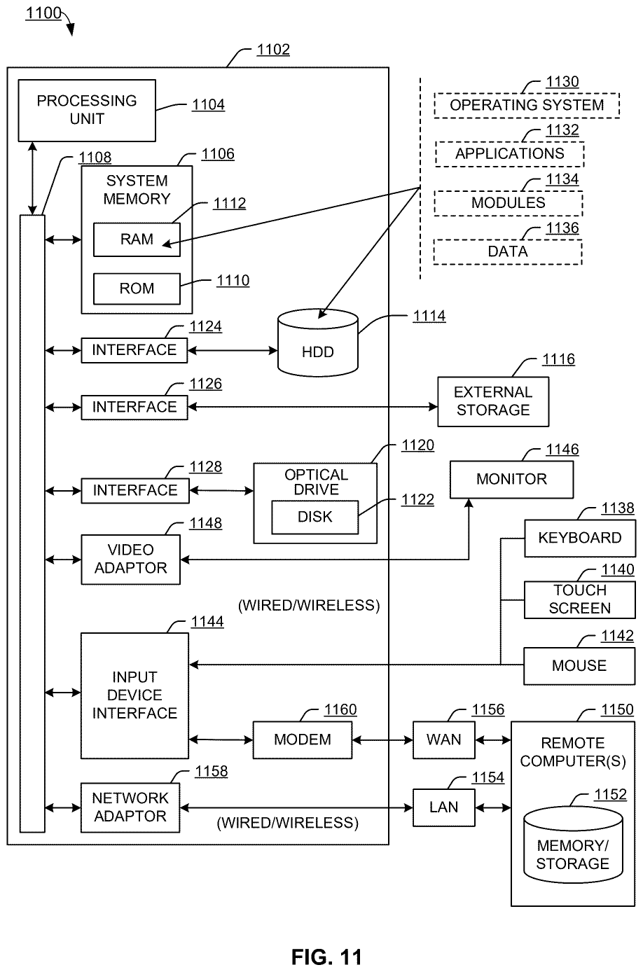

Each of computer system 102, user computer 106, and/or nodes 112 can be implemented with part(s) of computing environment 1100 of FIG. 11. Communications network 104 can comprise a computer communications network, such as the Internet, or an isolated private computer communications network.

Computer system 102 can comprise a cloud computing platform that provides computer services to user computer 106. User computer 106 can make a request to computer system 102 via communications network 104, and serving that request can comprise executing one or more microservices of microservices 110.

There can be various possibilities for assigning which microservices of microservices 110 to execute on which nodes of nodes 112. Workload placement in a containerized application environment component 108, as described herein.

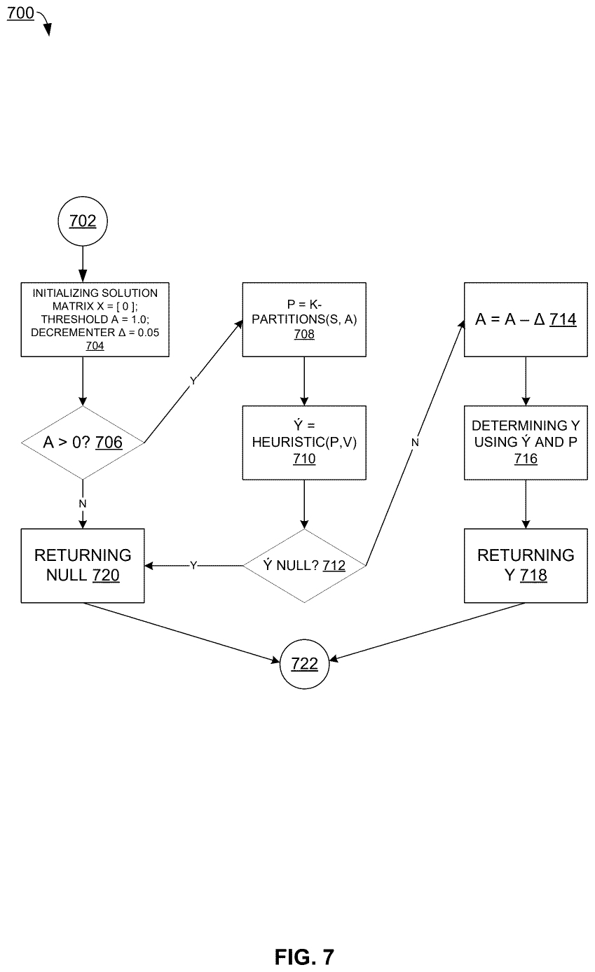

In some examples, workload placement in a containerized application environment component 108 can implement part(s) of the process flows of FIGS. 7-10 to facilitate workload placement in a containerized application environment.

It can be appreciated that system architecture 100 is one example system architecture for workload placement in a containerized application environment, and that there can be other system architectures that facilitate workload placement in a containerized application environment.

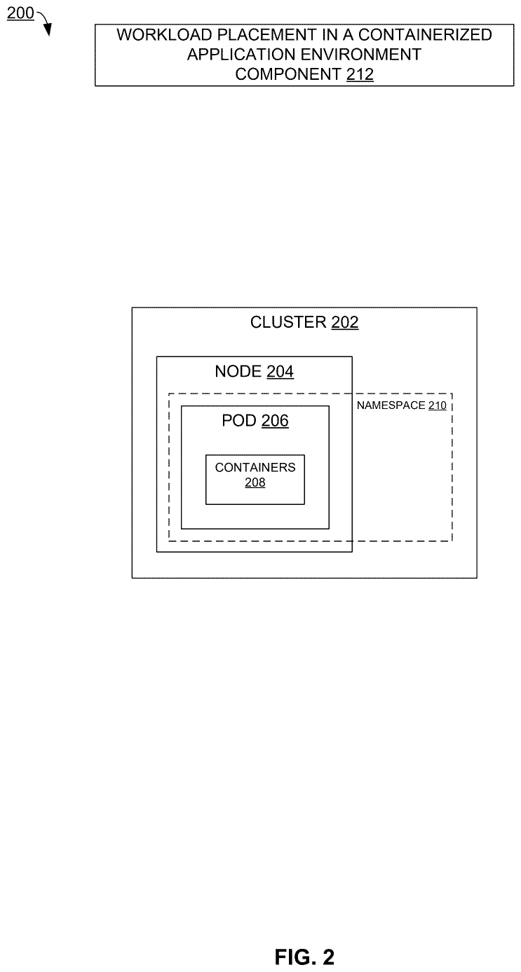

FIG. 2 illustrates another example system architecture 200 that can facilitate workload placement in a containerized application environment, in accordance with an embodiment of this disclosure. In some examples, part(s) of system architecture 200 can be implemented by part(s) of system architecture 100 of FIG. 1 to facilitate workload placement in a containerized application environment.

System architecture 200 comprises cluster 202, node 204, pod 206, containers 208, namespace 210, and workload placement in a containerized application environment component 212 (which can be similar to workload placement in a containerized application environment component 108 of FIG. 1).

The present techniques can be implemented to determine an optimized placement for microservices of a service-based application across multiple host machines in a containerized application cluster using a hybrid approach of graph partitioning and heuristic placement.

An example deployment procedure according to the present techniques can comprise performing the following:
Configure each application as a deployment in containerized application manifests.
Utilize one pod per microservice, with the desired replica per pod.
Associate each deployment file with a respective service file to enable network communication.
Configure service files linked to specific ports for inter-microservice and external communication.
Determine a service type based on application requirements.
Specify an initial number of nodes and resource allocation for each node.
Inject service mesh envoy proxies into each application's pod.
Redirect network traffic through envoy proxies for internal and external communication.
For monitoring, install service mesh services as pods within the cluster's nodes.
Install node exporters in each cluster's node to monitor resources.
Utilize a containerized application scheduler to place service mesh services within a cluster's nodes.
Ensure communication through a service mesh's data plane via pods' envoy proxies.
Manage node and pod creation and monitoring within the containerized application cluster.

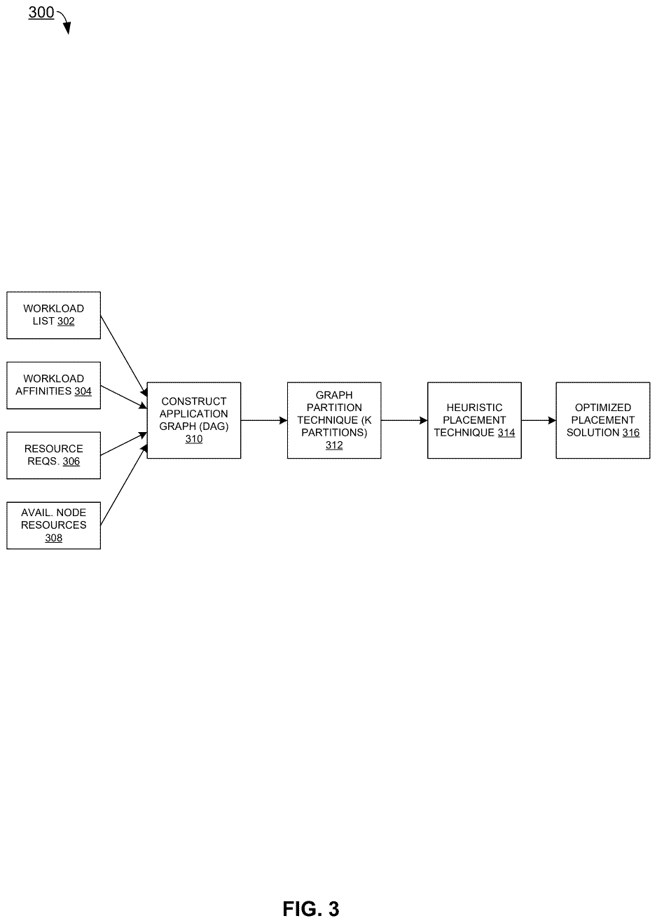

FIG. 3 illustrates another example system architecture 300 that can facilitate workload placement in a containerized application environment, in accordance with an embodiment of this disclosure. In some examples, part(s) of system architecture 300 can be implemented by part(s) of system architecture 100 of FIG. 1 to facilitate workload placement in a containerized application environment.

System architecture 300 comprises:
Input data:
   Workload list 302: A list of workloads/micro-services in the application to be deployed.
   Workload affinities 304: E.g. service-to-service traffic rates, data-stickiness, and/or central processing unit (CPU) load-sharing.
   Resource requirements 306: E.g., compute, memory, storage, and/or network bandwidth/throughput
   Available node resources 308, within a cluster.
Construct application graph (DAG) 310: Directed Graph G can be constructed with the nodes representing the application's microservices and the edges representing—for example—the weights of the communication traffic rates (or the service affinity rates).
Graph partition technique (K partitions) 312: This can partition the workloads into k partitions based on their affinities, producing partitioned applications.
Heuristic placement technique 314: This can take the partitioned application and attempt to find an optimized placement of the microservices across the available nodes in the cluster.
Optimized placement solution 316: This can be the final output of system architecture 300, representing an optimized placement of microservices across the nodes or virtual machines (VMs) in the containerized application cluster.

Further detail of these components is provided below.

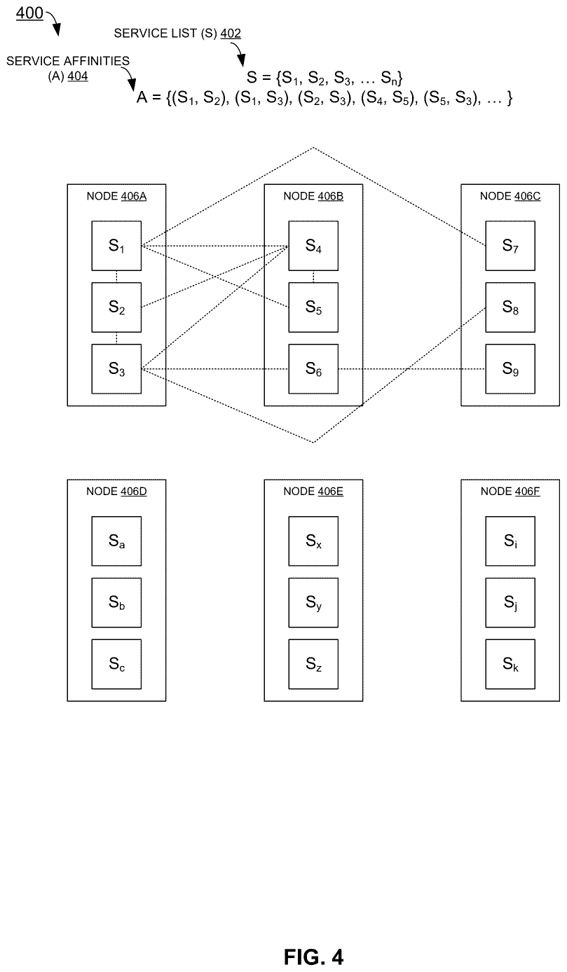

FIG. 4 illustrates an example 400 of application graph construction, and that can facilitate workload placement in a containerized application environment, in accordance with an embodiment of this disclosure. In some examples, part(s) of example 400 can be implemented by part(s) of system architecture 100 of FIG. 1 to facilitate workload placement in a containerized application environment.

Example 400 comprises service list(S) 402, service affinities (A) 404, node 406A, node 406B, node 406C, node 406D, node 406E, and node 406F.

Application graph construction can be implemented as follows.

Given an application's set of services and their affinities, graph G can be constructed.

Inputs to application graph construction can comprise:
Service list(S) 402: A list of all microservices in the application.
Service affinities (A) 404: A list or matrix representing the communication affinities or traffic rates between pairs of microservices.

Example steps to construct the graph G are as follows:
Initialize an empty graph G.
Iterate over every source service u in the list of service affinities A.
For each destination service v that has an affinity with u, if the service pair (u, v) exists in the service list S, and there is no edge from u to v in G, create a directed edge G(u→v) in the graph.
After processing all source services and their affinities, return the constructed graph G.

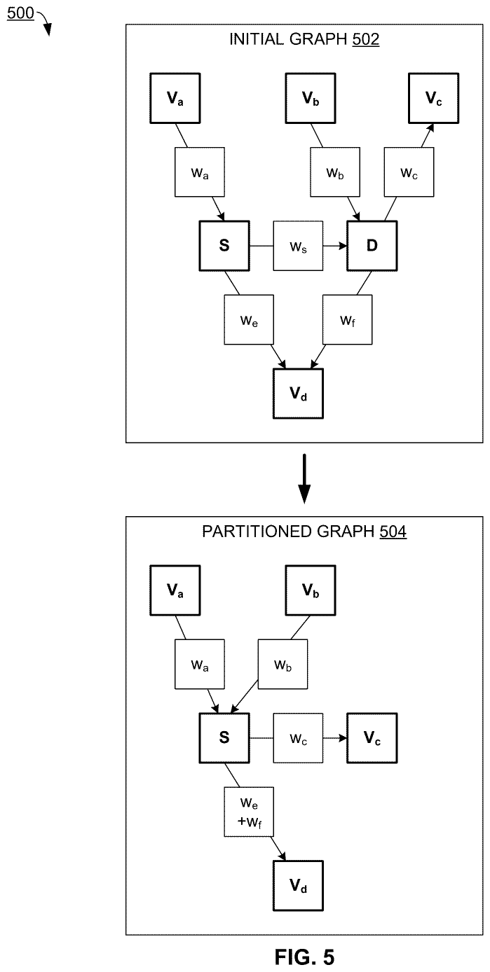

FIG. 5 illustrates an example 500 of graph partitioning, and that can facilitate workload placement in a containerized application environment, in accordance with an embodiment of this disclosure. In some examples, part(s) of example 500 can be implemented by part(s) of system architecture 100 of FIG. 1 to facilitate workload placement in a containerized application environment.

Example 500 comprises initial graph 502 and partitioned graph 504.

Graph partitioning can be performed as follows. A generic graph-partition technique can be applied to an undirected graph. Since a microservice-based workload environment can be modeled as a directed graph, a generic approach can be modified to apply it to a directed graph. In the given graph G, a modified K-partition technique can consolidate selected vertexes S (src) and D (dest) to rearrange incoming/outgoing affinities from the dest to src, as follows:
Randomly choose an edge from the graph with probability proportional to the weight of the edge.
To remove an edge, examine whether the selected dest vertex has affinity edges with other vertexes in G.
If required, redirect all affinities from the dest vertex to the selected src vertex as shown in FIG. 5.
Merge the node assigned to this edge into one node
Iteratively select a random edge and remove it described above until the graph contains only the desired nodes.

This approach can return an updated graph G with only k vertices and k−1 edges.

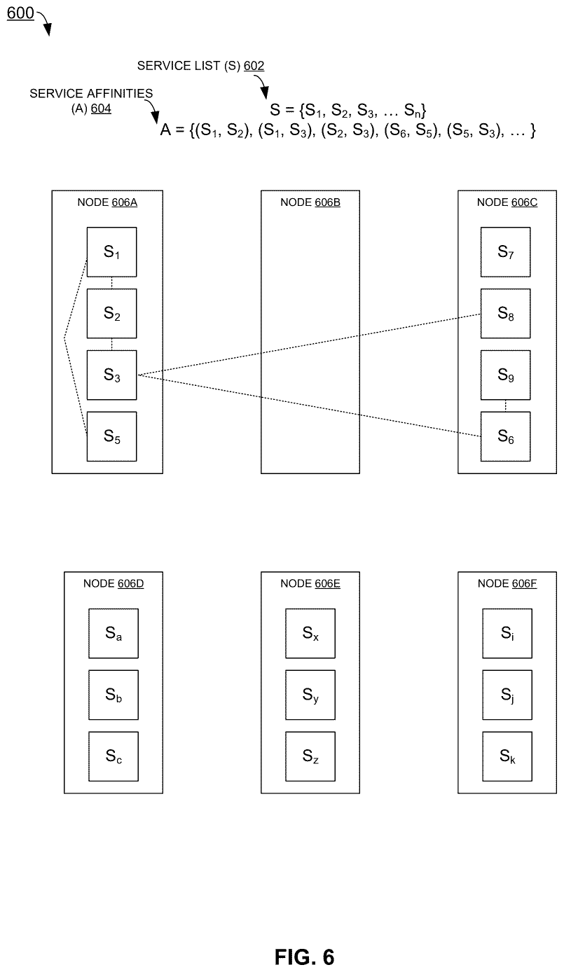

FIG. 6 illustrates an example 600 of heuristic placement, and that can facilitate workload placement in a containerized application environment, in accordance with an embodiment of this disclosure. In some examples, part(s) of example 600 can be implemented by part(s) of system architecture 100 of FIG. 1 to facilitate workload placement in a containerized application environment.

Heuristic placement according to the present techniques can be implemented as follows:
Determine the available and allocated node resources, excluding the requested resources for each pod.
For each partition produced by the partitioning technique:
   Calculate the total CPU and random access memory (RAM) requests for the partition.
   Find the suitable node to host the partition based on available resources, traffic rates, CPU load, and RAM load.
   Repeat for all partitions.
Sort the application's microservices affinities in descending order.
For each affinity edge:
   If the microservices are on the same node, mark them as moved.
   Otherwise, try to move the destination microservice to the source node, or vice versa, based on available resources.
   Redetermine available and allocated resources for the next iteration.

### Example Procss Flows

FIG. 7 illustrates an example process flow 700 that can facilitate workload placement in a containerized application environment, in accordance with an embodiment of this disclosure. In some examples, one or more embodiments of process flow 700 can be implemented by system architecture 100 of FIG. 1, or computing environment 1100 of FIG. 11.

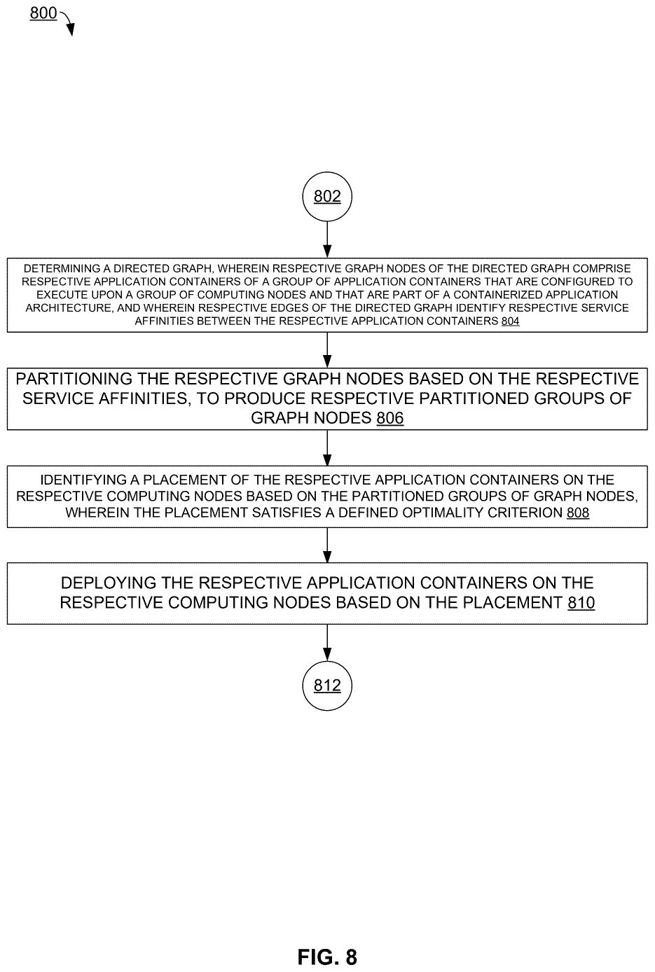

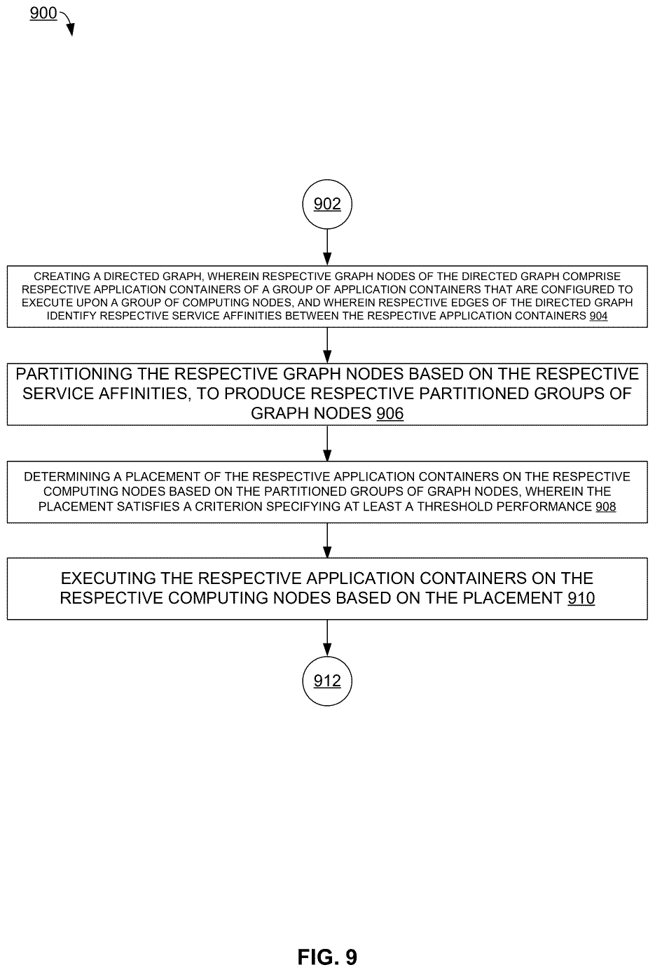

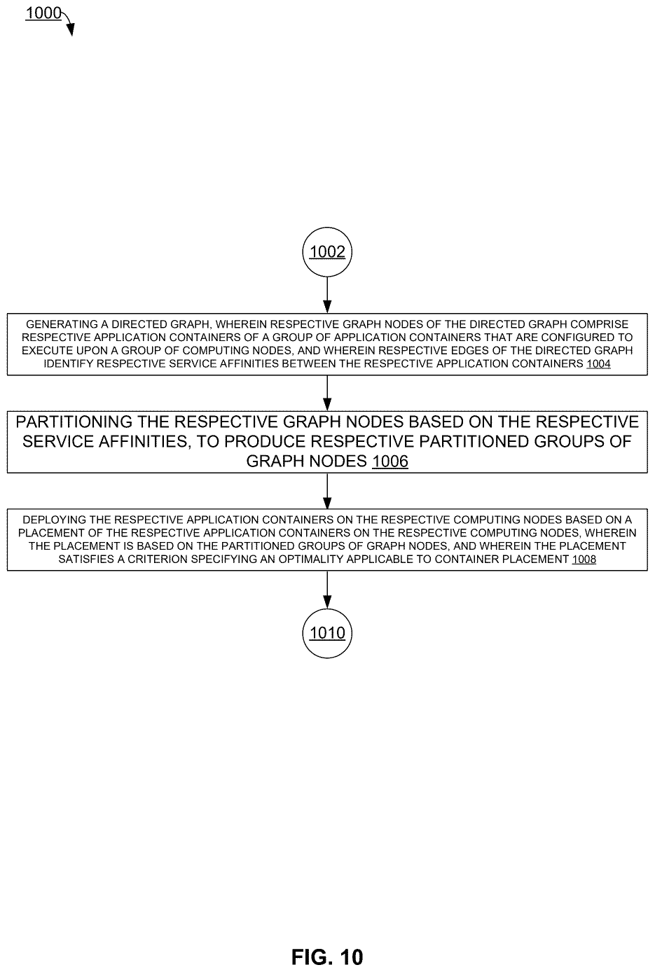

It can be appreciated that the operating procedures of process flow 700 are example operating procedures, and that there can be embodiments that implement more or fewer operating procedures than are depicted, or that implement the depicted operating procedures in a different order than as depicted. In some examples, process flow 700 can be implemented in conjunction with one or more embodiments of process flow 800 of FIG. 8, process flow 900 of FIG. 9, and/or process flow 1000 of FIG. 10.

Process flow 700 begins with 702, and moves to operation 704.

Operation 704 depicts initializing solution matrix X=[0]; threshold α=1.0; decrementer Δ=0.05.

After operation 704, process flow 700 moves to operation 706.

Operation 706 depicts determining whether a is greater than 0.

Where in operation 706 it is determined that a is greater than 0, process flow 700 moves to operation 708. Instead, where in operation 706 it is determined that a is not greater than 0, process flow 700 moves to operation 720.

Operation 708 is reached from operation 706 where it is determined that a is greater than 0. Operation 708 depicts setting P=K−Partitions (S, α).

After operation 708, process flow 700 moves to operation 710.

Operation 710 depicts setting Ý=Heuristic (P,V).

After operation 710, process flow 700 moves to operation 712.

Operation 712 depicts determining whether Ý is null.

Where in operation 712 it is determined that Ý is not null, process flow 700 moves to operation 714. Instead, where in Where in operation 712 it is determined that Ý is null, process flow 700 moves to operation 720.

Operation 714 is reached from operation 712 where it is determined that Ý is not null. Operation 714 depicts setting α=α−Δ.

After operation 714, process flow 700 moves to operation 716.

Operation 716 depicts determining Y using Ý and P.

After operation 716, process flow 700 moves to operation 718.

Operation 718 depicts returning Y.

After operation 718, process flow 700 moves to 722, where process flow 700 ends.

Operation 720 is reached from operation 706 (where it is determined that α is not greater than 0) or from operation 712 (where it is determined that Ý is null). Operation 720 depicts returning null.

After operation 720, process flow 700 moves to 722, where process flow 700 ends.

α can be a control mechanism to manage the resource allocation during the partitioning of services, preventing any partition from exceeding a set proportion of the available resources.

It can be defined as a threshold value that serves as ann upper bound for the resource demands of partitioned parts of an application. This threshold can ensure that when partitioning services to be allocated to nodes/virtual machines (VMs), the total resource demands from each partition do not exceed a certain limit. Before applying a, the resource demands and capacities can be normalized based on maximum available resources of each host machine. So, a can represent the maximum fraction (ranging between 0 and 1) of the total normalized resources that any single partition can demand. The partitioning techniques can continue to divide the services until the resource demand of each partition is within this a threshold, ensuring efficient utilization of resources without overloading any node/VM.

It can be that graph partition and heuristic placement techniques cannot guarantee that a placement solution will be found upon each execution. Also, it can be possible that the techniques will not converge for a finite number of iterations. So, a threshold a and a step decrementer Δ can be used to partition the application and attempt to place the generated partitions into the available hosts in a deterministic/finite way. Since an objective function can involve reducing inter-node traffic, a higher α value can represent less traffic and a more desirable solution. An α of 1 can be considered to be the “best solution” and a value of 0 can be considered to be “no available solution.” Δ can be a decrementer to control how many iterations to run to make the technique converge.

Sorting an application's microservices affinities in descending order can be performed, because, in this way, microservices with a higher affinity metric (or graph weight) can be processed first, and the produced service placement can become as optimal as possible (or satisfactory).

Put another way relative to process flow 700, a complete workflow of an example of the present techniques is as follows:
1. Initialize the placement solution Y to an empty matrix.
2. Set the initial value of α to 1.0 and Δ to 0.1.
3. Repeat the process as long as α>=0.0:
   a. Partition the application S using a K-Partition (S, α) approach, producing partitions P.
   b. Apply the heuristic technique to find a placement solution Y′ for the partitions P across the available machines.
   c. If Y′ is not null, a placement solution was found. Determine the final placement solution X according to X′ and P. Return X and exit the workflow.
   d. If no placement solution was found, decrement α by Δ.
4. If the loop terminates without finding a placement solution, return Null.

This workflow can iteratively try to find a placement solution by partitioning the application using different values of the threshold α. It can start with α=1.0, and decrement it by Δ (0.1) in each iteration, if no placement solution is found. If a placement solution is found, it can be returned. Otherwise, the workflow can continue with a smaller value of a until either a solution is found or a becomes less than 0.0, at which point the workflow can return Null, indicating that no placement solution could be found.

FIG. 8 illustrates another example process flow 800 that can facilitate workload placement in a containerized application environment, in accordance with an embodiment of this disclosure. In some examples, one or more embodiments of process flow 800 can be implemented by system architecture 100 of FIG. 1, or computing environment 1100 of FIG. 11.

It can be appreciated that the operating procedures of process flow 800 are example operating procedures, and that there can be embodiments that implement more or fewer operating procedures than are depicted, or that implement the depicted operating procedures in a different order than as depicted. In some examples, process flow 800 can be implemented in conjunction with one or more embodiments of process flow 700 of FIG. 7, process flow 900 of FIG. 9, and/or process flow 1000 of FIG. 10.

Process flow 800 begins with 802, and moves to operation 804.

Operation 804 depicts determining a directed graph, wherein respective graph nodes of the directed graph comprise respective application containers of a group of application containers that are configured to execute upon a group of computing nodes and that are part of a containerized application architecture, and wherein respective edges of the directed graph identify respective service affinities between the respective application containers. This can be implemented in a similar manner as construct application graph 310 of FIG. 3.

In some examples, a telecommunications application comprises the group of application containers. That is, the present techniques can be implemented to place telco application workloads on nodes of a cluster.

In some examples, the respective service affinities represent respective rates of network communications between the respective application containers, respective amounts of data shared between the respective application containers, respective amounts of processor load sharing between the respective application containers, respective traffic rates between the respective application containers, or respective amounts of memory sharing between the respective application containers.

In some examples, the determining of the directed graph comprises iterating over each source application container of the group of application containers that is identified in a list of the service affinities; and for each of the source application containers, for each corresponding destination application container of the group of application containers, where an identification of a pair comprising the source application container and the destination application container exists in a service list, and where an edge from a first node of the directed graph that corresponds to the source application container and a second node of the directed graph that corresponds to the destination application container does not exist in the directed graph, creating the edge in the directed graph.

After operation 804, process flow 800 moves to operation 806.

Operation 806 depicts partitioning the respective graph nodes based on the respective service affinities, to produce respective partitioned groups of graph nodes. This can be implemented in a similar manner as graph partition technique 312 of FIG. 3.

In some examples, the graph nodes comprise a source node and a destination node, and partitioning the respective graph nodes comprises consolidating the source node and the destination node. That is, a K-partition technique can be implemented that consolidates selected vertexes S (src) and D (dest) to rearrange incoming/outgoing affinities from the dest to src.

In some examples, the directed graph is a first directed graph, the graph nodes are first graph nodes, the edges are first edges, a second directed graph comprises the respective partitioned groups of graph nodes, the second directed graph comprises a first number of second graph nodes and a second number of second edges, and the first number is one greater than the second number. That is, a result of graph partitioning can be to produce an updated graph G with k vertices and k−1 edges.

In some examples, operation 806 comprises producing the second directed graph from the first directed graph, comprising, performing iterations of randomly selecting a first edge of the first edges with a probability proportional to a weight of the first edge, and redirecting edges of the first edges from a destination node that corresponds to the first edge to a source node that corresponds to the first edge.

After operation 806, process flow 800 moves to operation 808.

Operation 808 depicts identifying a placement of the respective application containers on the respective computing nodes based on the partitioned groups of graph nodes, wherein the placement satisfies a defined optimality criterion. This can be implemented in a similar manner as heuristic placement technique 314 of FIG. 3.

In some examples, the identifying of the placement of the respective application containers on the respective computing nodes is based on respective resource availabilities for the respective application containers, and wherein the respective resource availabilities comprise respective compute resources, respective memory resources, respective storage resources, respective network bandwidths, or respective network throughputs. That is, workloads can have resource requirements.

In some examples, the respective resource availabilities for the respective application containers comprises respective microservices resource availabilities for respective microservices that execute within the respective application containers, and wherein the respective resource availabilities for the respective application containers omit respective resource availabilities of the respective application containers. That is, nodes can have available and allocated resources, and these can be determined by excluding requested resources for each pod.

In some examples, the identifying of the placement of the respective application containers on the respective computing nodes based on the partitioned groups of graph nodes comprises, for each of the partitioned groups of graph nodes, determining total computing resources to allocate for respective application containers that correspond to the respective partitioned groups of graph nodes, and identifying respective computing nodes of the computing nodes on which to host the respective application containers based on respective available computing resources of the respective computing nodes. That is, in some examples, for each partition produced by the partition technique, determine the total CPU and RAM requests for the partition, find the suitable node to host the partition based on available resources, traffic rates, CPU load, and RAM load, and repeat for all partitions.

In some examples, operation 808 comprises sorting respective first service affinities of the service affinities that correspond to a first application container of the application containers by descending service affinity values, to produce sorted service affinities, and for each service affinity of the sorted service affinities, where a second application container that corresponds to the service affinity is placed on a same computing node as the first application container, marking the first application container and the second application container as successfully moved.

In some examples, operation 808 comprises sorting respective first service affinities of the service affinities that correspond to a first application container of the application containers by descending service affinity values, to produce sorted service affinities; and for each service affinity of the sorted service affinities, and where a second application container that corresponds to the service affinity is not placed on a same computing node as the first application container, moving the second application container and to a first computing node of the first application container where the first computing node has first available resources to execute the second application container, or moving the first application container and to a second computing node of the second application container where the second computing node has second available resources to execute the first application container.

That is, the following can occur. If the microservices are on the same node, mark them as moved. Otherwise, try to move the destination microservice to the source node, or vice versa, based on available resources. Then, redetermine available and allocated resources for the next iteration.

After operation 808, process flow 800 moves to operation 810.

Operation 810 depicts deploying the respective application containers on the respective computing nodes based on the placement. That is, a result of optimized placement solution 316 of FIG. 3 can be used to place specific microservices of microservices 110 of FIG. 1 on specific nodes of nodes 112.

After operation 810, process flow 800 moves to 812, where process flow 800 ends.

FIG. 9 illustrates another example process flow 900 that can facilitate workload placement in a containerized application environment, in accordance with an embodiment of this disclosure. In some examples, one or more embodiments of process flow 900 can be implemented by system architecture 100 of FIG. 1, or computing environment 1100 of FIG. 11.

It can be appreciated that the operating procedures of process flow 900 are example operating procedures, and that there can be embodiments that implement more or fewer operating procedures than are depicted, or that implement the depicted operating procedures in a different order than as depicted. In some examples, process flow 900 can be implemented in conjunction with one or more embodiments of process flow 700 of FIG. 7, process flow 800 of FIG. 8, and/or process flow 1000 of FIG. 10.

Process flow 900 begins with 902, and moves to operation 904.

Operation 904 depicts creating a directed graph, wherein respective graph nodes of the directed graph comprise respective application containers of a group of application containers that are configured to execute upon a group of computing nodes, and wherein respective edges of the directed graph identify respective service affinities between the respective application containers. In some examples, operation 904 can be implemented in a similar manner as operation 804 of FIG. 8.

In some examples, operation 904 comprises, for each source application container of the group of application containers that is identified in a list of the service affinities, for each corresponding destination application container of the group of application containers, where an identification of a pair comprising the source application container and the destination application container exists in a service list, and where an edge from a first node of the directed graph that corresponds to the source application container and a second node of the directed graph that corresponds to the destination application container does not exist in the directed graph, adding the edge to the directed graph.

After operation 904, process flow 900 moves to operation 906.

Operation 906 depicts partitioning the respective graph nodes based on the respective service affinities, to produce respective partitioned groups of graph nodes. In some examples, operation 906 can be implemented in a similar manner as operation 806 of FIG. 8.

In some examples, the directed graph is a first directed graph, the graph nodes are first graph nodes, the edges are first edges, a second directed graph comprises the respective partitioned groups of graph nodes, operation 906 comprises producing the second directed graph from the first directed graph based on, performing iterations of randomly selecting a first edge of the first edges with a probability proportional to a weight of the first edge, and redirecting edges of the first edges from a destination node that corresponds to the first edge to a source node that corresponds to the first edge.

After operation 906, process flow 900 moves to operation 908.

Operation 908 depicts determining a placement of the respective application containers on the respective computing nodes based on the partitioned groups of graph nodes, wherein the placement satisfies a criterion specifying at least a threshold performance. In some examples, operation 908 can be implemented in a similar manner as operation 808 of FIG. 8.

In some examples, operation 908 comprises, for each service affinity of the service affinities of a first application container, and where a second application container that corresponds to the service affinity is not placed on a same computing node as the first application container, moving the second application container and to a first computing node of the first application container in response to determining that the first computing node has available resources to execute the second application container, or moving the first application container and to a second computing node of the second application container in response to determining that the second computing node has available resources to execute the first application container.

After operation 908, process flow 900 moves to operation 910.

Operation 910 depicts executing the respective application containers on the respective computing nodes based on the placement. In some examples, operation 910 can be implemented in a similar manner as operation 810 of FIG. 8.

After operation 910, process flow 900 moves to 912, where process flow 900 ends.

FIG. 10 illustrates another example process flow 1000 that can facilitate workload placement in a containerized application environment, in accordance with an embodiment of this disclosure. In some examples, one or more embodiments of process flow 1000 can be implemented by system architecture 100 of FIG. 1, or computing environment 1100 of FIG. 11.

It can be appreciated that the operating procedures of process flow 1000 are example operating procedures, and that there can be embodiments that implement more or fewer operating procedures than are depicted, or that implement the depicted operating procedures in a different order than as depicted. In some examples, process flow 1000 can be implemented in conjunction with one or more embodiments of process flow 700 of FIG. 7, process flow 800 of FIG. 8, and/or process flow 900 of FIG. 9.

Process flow 1000 begins with 1002, and moves to operation 1004.

Operation 1004 depicts generating a directed graph, wherein respective graph nodes of the directed graph comprise respective application containers of a group of application containers that are configured to execute upon a group of computing nodes, and wherein respective edges of the directed graph identify respective service affinities between the respective application containers. In some examples, operation 1004 can be implemented in a similar manner as operation 804 of FIG. 8.

In some examples, operation 1004 comprises, for each source application container of the group of application containers that is identified in a list of the service affinities, for each corresponding destination application container of the group of application containers, adding an edge to the directed graph in response to identifying a pair, comprising the source application container and the destination application container, exists in a service list, and in response to determining that the edge from a first node of the directed graph that corresponds to the source application container and a second node of the directed graph that corresponds to the destination application container does not exist in the directed graph. After operation 1004, process flow 1000 moves to operation 1006.

Operation 1006 depicts partitioning the respective graph nodes based on the respective service affinities, to produce respective partitioned groups of graph nodes. In some examples, operation 1006 can be implemented in a similar manner as operation 806 of FIG. 8.

In some examples, the directed graph is a first directed graph, wherein the graph nodes are first graph nodes, wherein the edges are first edges, a second directed graph comprises the respective partitioned groups of graph nodes, and operation 1006 comprises producing the second directed graph from the first directed graph based on, performing iterations of randomly selecting a first edge of the first edges with a probability proportional to a weight of the first edge, and redirecting edges of the first edges from a destination node that corresponds to the first edge to a source node that corresponds to the first edge.

After operation 1006, process flow 1000 moves to operation 1008.

Operation 1008 depicts deploying the respective application containers on the respective computing nodes based on a placement of the respective application containers on the respective computing nodes, wherein the placement is based on the partitioned groups of graph nodes, and wherein the placement satisfies a criterion specifying an optimality applicable to container placement. In some examples, operation 1008 can be implemented in a similar manner as operations 808-810 of FIG. 8.

In some examples, operation 1008 comprises, for each service affinity of the service affinities of a first application container, in response to determining that a second application container that corresponds to the service affinity is not placed on a same computing node as the first application container and in response to determining that the same computing node has available resources to execute the first application container and to execute the second application container, placing the second application container and the first application container on the same computing node.

After operation 1008, process flow 1000 moves to 1010, where process flow 1000 ends.

### Example Operating Environment

In order to provide additional context for various embodiments described herein, FIG. 11 and the following discussion are intended to provide a brief, general description of a suitable computing environment 1100 in which the various embodiments of the embodiment described herein can be implemented.

For example, parts of computing environment 1100 can be used to implement one or more embodiments of base station 102 and/or UEs of UEs 106 of FIG. 1.

In some examples, computing environment 1100 can implement one or more embodiments of the process flows of FIGS. 7-10 to facilitate workload placement in a containerized application environment.

While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various embodiments described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a nonvolatile storage such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), one or more external storage devices 1116 (e.g., a magnetic floppy disk drive (FDD) 1116, a memory stick or flash drive reader, a memory card reader, etc.) and an optical disk drive 1120 (e.g., which can read or write from a CD-ROM disc, a DVD, a BD, etc.). While the internal HDD 1114 is illustrated as located within the computer 1102, the internal HDD 1114 can also be configured for external use in a suitable chassis (not shown). Additionally, while not shown in environment 1100, a solid state drive (SSD) could be used in addition to, or in place of, an HDD 1114. The HDD 1114, external storage device(s) 1116 and optical disk drive 1120 can be connected to the system bus 1108 by an HDD interface 1124, an external storage interface 1126 and an optical drive interface 1128, respectively. The interface 1124 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the .NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1394 serial port, a game port, a USB port, an IR interface, a BLUETOOTH® interface, etc.

A monitor 1146 or other type of display device can be also connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the Internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are examples, and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1116 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### CONCLUSION

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations”, this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
at least one processor; and
at least one memory that stores executable instructions that, when executed by the at least one processor, facilitate performance of operations, comprising:
determining a directed graph, wherein respective graph nodes of the directed graph comprise respective application containers of a group of application containers that are configured to execute upon a group of computing nodes and that are part of a containerized application architecture, and wherein respective edges of the directed graph identify respective service affinities between the respective application containers;
partitioning the respective graph nodes based on the respective service affinities, to produce respective partitioned groups of graph nodes;
identifying a placement of the respective application containers on the respective computing nodes based on the partitioned groups of graph nodes, wherein the placement satisfies a defined optimality criterion; and
deploying the respective application containers on the respective computing nodes based on the placement.

2. The system of claim 1, wherein a telecommunications application comprises the group of application containers.

3. The system of claim 1, wherein the respective service affinities represent respective rates of network communications between the respective application containers, respective amounts of data shared between the respective application containers, respective amounts of processor load sharing between the respective application containers, respective traffic rates between the respective application containers, or respective amounts of memory sharing between the respective application containers.

4. The system of claim 1, wherein the identifying of the placement of the respective application containers on the respective computing nodes is based on respective resource availabilities for the respective application containers, and wherein the respective resource availabilities comprise respective compute resources, respective memory resources, respective storage resources, respective network bandwidths, or respective network throughputs.

5. The system of claim 4, wherein the respective resource availabilities for the respective application containers comprises respective microservices resource availabilities for respective microservices that execute within the respective application containers, and wherein the respective resource availabilities for the respective application containers omit respective resource availabilities of the respective application containers.

6. The system of claim 1, wherein the determining of the directed graph comprises:
iterating over each source application container of the group of application containers that is identified in a list of the service affinities; and
for each of the source application containers,
for each corresponding destination application container of the group of application containers,
where an identification of a pair comprising the source application container and the destination application container exists in a service list, and
where an edge from a first node of the directed graph that corresponds to the source application container and a second node of the directed graph that corresponds to the destination application container does not exist in the directed graph,
creating the edge in the directed graph.

7. The system of claim 1, wherein the graph nodes comprise a source node and a destination node, and wherein partitioning the respective graph nodes comprises consolidating the source node and the destination node.

8. The system of claim 1, wherein the directed graph is a first directed graph, wherein the graph nodes are first graph nodes, wherein the edges are first edges, wherein a second directed graph comprises the respective partitioned groups of graph nodes, wherein the second directed graph comprises a first number of second graph nodes and a second number of second edges, and wherein the first number is one greater than the second number.

9. The system of claim 8, wherein the operations further comprise:
producing the second directed graph from the first directed graph, comprising,
performing iterations of randomly selecting a first edge of the first edges with a probability proportional to a weight of the first edge; and
redirecting edges of the first edges from a destination node that corresponds to the first edge to a source node that corresponds to the first edge.

10. The system of claim 1, wherein the identifying of the placement of the respective application containers on the respective computing nodes based on the partitioned groups of graph nodes comprises:
for each of the partitioned groups of graph nodes,
determining total computing resources to allocate for respective application containers that correspond to the respective partitioned groups of graph nodes, and
identifying respective computing nodes of the computing nodes on which to host the respective application containers based on respective available computing resources of the respective computing nodes.

11. The system of claim 10, wherein the operations further comprise:
sorting respective first service affinities of the service affinities that correspond to a first application container of the application containers by descending service affinity values, to produce sorted service affinities; and
for each service affinity of the sorted service affinities, where a second application container that corresponds to the service affinity is placed on a same computing node as the first application container, marking the first application container and the second application container as successfully moved.

12. The system of claim 10, wherein the operations further comprise:
sorting respective first service affinities of the service affinities that correspond to a first application container of the application containers by descending service affinity values, to produce sorted service affinities; and
for each service affinity of the sorted service affinities, and where a second application container that corresponds to the service affinity is not placed on a same computing node as the first application container,
moving the second application container and to a first computing node of the first application container where the first computing node has first available resources to execute the second application container, or
moving the first application container and to a second computing node of the second application container where the second computing node has second available resources to execute the first application container.

13. A method, comprising:
creating, by a system comprising at least one processor, a directed graph, wherein respective graph nodes of the directed graph comprise respective application containers of a group of application containers that are configured to execute upon a group of computing nodes, and wherein respective edges of the directed graph identify respective service affinities between the respective application containers;
partitioning, by the system, the respective graph nodes based on the respective service affinities, to produce respective partitioned groups of graph nodes;
determining, by the system, a placement of the respective application containers on the respective computing nodes based on the partitioned groups of graph nodes, wherein the placement satisfies a criterion specifying at least a threshold performance; and
executing, by the system, the respective application containers on the respective computing nodes based on the placement.

14. The method of claim 13, wherein the creating of the directed graph comprises:
for each source application container of the group of application containers that is identified in a list of the service affinities,
for each corresponding destination application container of the group of application containers,
where an identification of a pair comprising the source application container and the destination application container exists in a service list, and
where an edge from a first node of the directed graph that corresponds to the source application container and a second node of the directed graph that corresponds to the destination application container does not exist in the directed graph,
adding, by the system, the edge to the directed graph.

15. The method of claim 13, wherein the directed graph is a first directed graph, wherein the graph nodes are first graph nodes, wherein the edges are first edges, wherein a second directed graph comprises the respective partitioned groups of graph nodes, and further comprising:
producing, by the system, the second directed graph from the first directed graph based on,
performing iterations of randomly selecting a first edge of the first edges with a probability proportional to a weight of the first edge, and
redirecting edges of the first edges from a destination node that corresponds to the first edge to a source node that corresponds to the first edge.

16. The method of claim 13, further comprising:
for each service affinity of the service affinities of a first application container, and where a second application container that corresponds to the service affinity is not placed on a same computing node as the first application container,
moving, by the system, the second application container and to a first computing node of the first application container in response to determining that the first computing node has available resources to execute the second application container, or
moving, by the system, the first application container and to a second computing node of the second application container in response to determining that the second computing node has available resources to execute the first application container.

17. A non-transitory computer-readable medium comprising instructions that, in response to execution, cause a system comprising at least one processor to perform operations, comprising:
generating a directed graph, wherein respective graph nodes of the directed graph comprise respective application containers of a group of application containers that are configured to execute upon a group of computing nodes, and wherein respective edges of the directed graph identify respective service affinities between the respective application containers;
partitioning the respective graph nodes based on the respective service affinities, to produce respective partitioned groups of graph nodes; and
deploying the respective application containers on the respective computing nodes based on a placement of the respective application containers on the respective computing nodes, wherein the placement is based on the partitioned groups of graph nodes, and wherein the placement satisfies a criterion specifying an optimality applicable to container placement.

18. The non-transitory computer-readable medium of claim 17, wherein the creating of the directed graph comprises:
for each source application container of the group of application containers that is identified in a list of the service affinities, for each corresponding destination application container of the group of application containers,
adding an edge to the directed graph in response to identifying a pair, comprising the source application container and the destination application container, exists in a service list, and
in response to determining that the edge from a first node of the directed graph that corresponds to the source application container and a second node of the directed graph that corresponds to the destination application container does not exist in the directed graph.

19. The non-transitory computer-readable medium of claim 17, wherein the directed graph is a first directed graph, wherein the graph nodes are first graph nodes, wherein the edges are first edges, wherein a second directed graph comprises the respective partitioned groups of graph nodes, and wherein the operations further comprise:
producing the second directed graph from the first directed graph based on, performing iterations of randomly selecting a first edge of the first edges with a probability proportional to a weight of the first edge, and redirecting edges of the first edges from a destination node that corresponds to the first edge to a source node that corresponds to the first edge.

20. The non-transitory computer-readable medium of claim 17, wherein the operations further comprise:
for each service affinity of the service affinities of a first application container, in response to determining that a second application container that corresponds to the service affinity is not placed on a same computing node as the first application container and in response to determining that the same computing node has available resources to execute the first application container and to execute the second application container, placing the second application container and the first application container on the same computing node.
